(19) United States
(12) Patent Application Publication
(10) Pub. No.: US 2025/0159413 A1
(43) Pub. Date: May 15, 2025

(54) LOUDSPEAKERS AND ELECTRONIC DEVICES

(71) Applicants: SHENZHEN SHOKZ CO., LTD., Shenzhen (CN); KING TONE INNOVATION (BEIJING) TECHNOLOGY CO. LTD., Beijing (CN)

(72) Inventors: Lei ZHANG, Shenzhen (CN); Peigeng TONG, Shenzhen (CN); GuoIin XIE, Shenzhen (CN); Shanyong GU, Beijing (CN); Hongqiang ZHAO, Beijing (CN); Xin QI, Shenzhen (CN)

(73) Assignees: SHENZHEN SHOKZ CO., LTD., Shenzhen (CN); KING TONE INNOVATION (BEIJING) TECHNOLOGY CO. LTD., Beijing (CN)

(21) Appl. No.: 19/026,713

(22) Filed: Jan. 17, 2025

Related U.S. Application Data
(63) Continuation of application No. PCT/CN2022/143897, filed on Dec. 30, 2022.

(51) Int. Cl. H04R 9/02; H04R 9/06

(52) U.S. Cl. CPC H04R 9/025; H04R 9/06; H04R 2209/022

(57) ABSTRACT

A loudspeaker and an electronic device are provided. The loudspeaker includes a basket and a coil. The coil includes an annular body and a lead wire connected with the annular body. The annular body is located on an inner side of the basket. The lead wire moves along with the annular body relative to the basket after an excitation signal is input into the loudspeaker. A soldering pad is disposed on the basket. The lead wire is provided with a first end close to the annular body and a second end away from the annular body. The second end is fixed on the soldering pad. A ratio of a length of the lead wire to a maximum amplitude of a movement of the coil relative to the basket is in a range of 8-75. The technical problem of stress concentration in the lead wire is improved.

### CROSS-REFERENCE TO RELATED APPLICATION

This application is a continuation of International Application No. PCT/CN2022/143897, filed on Dec. 30, 2022, the contents of which are entirely incorporated herein by reference.

### TECHNICAL FIELD

The present disclosure relates to the technical field of electronic devices, and in particular to a loudspeaker and an electronic device.

### BACKGROUND

With the increasing popularity of electronic devices, the electronic devices have become indispensable social and entertainment tools in people's daily life, and people's requirements for electronic devices are also increasing. The electronic devices, such as earphones and smart glasses, have also been widely used in people's daily life, which can be used with terminal devices, such as mobile phones and computers, to provide users with an auditory feast.

### SUMMARY

One or more embodiments of the present disclosure provide a loudspeaker. The loudspeaker may comprise a basket and a coil. The coil may include an annular body and a lead wire connected with the annular body. The annular body may be located on an inner side of the basket. The lead wire may move along with the annular body relative to the basket after an excitation signal is input into the loudspeaker. A soldering pad may be disposed on the basket. The lead wire may be provided with a first end close to the annular body and a second end away from the annular body. The second end may be fixed on the soldering pad. A ratio of a length of the lead wire to a maximum amplitude of a movement of the coil relative to the basket may be in a range of 8-75.

In some embodiments, a ratio of a diameter of the lead wire to the length of the lead wire may be in a range of 50-1000.

In some embodiments, the lead wire may include a first extension portion connected with the annular body and a second extension portion bent relative to the first extension portion. A ratio of a length of the second extension portion to a length of the first extension portion may be in a range of 2-15.

In some embodiments, a distance between the second extension portion and the annular body in a direction perpendicular to a vibration direction of the loudspeaker may be in a range of 1.1 mm-2.1 mm.

In some embodiments, an angle between the second extension portion and the first extension portion may be an obtuse angle.

In some embodiments, the lead wire may be fixed on the basket at a fixed position between the first end and the second end, and a portion of the lead wire between the first end and the fixed position may be suspended relative to the basket.

In some embodiments, a support block may be disposed on the basket. The support block may be located between the first end and the second end and correspond to the fixed position. The lead wire may be fixed on the support block at the fixed position. When no excitation signal is input into the loudspeaker, the first end and the fixed position may be on a same reference plane perpendicular to the vibration direction of the loudspeaker.

In some embodiments, the loudspeaker may comprise a magnetic shield connected with the basket, a magnet disposed in the magnetic shield, a diaphragm connected with the coil, and a folded ring connecting the diaphragm and the basket. The coil may extend into a magnetic gap formed by the magnet and the magnetic shield. The diaphragm may include a body portion, a first annular connection portion, and a second annular connection portion which are integrally connected. The first annular connection portion may be connected with the coil. The second annular connection portion may be connected with the folded ring. An orthographic projection of the second annular connection portion in the vibration direction of the loudspeaker may cover the lead wire. The second annular connection portion may be bent towards a side away from the coil relative to the first annular connection portion.

In some embodiments, the folded ring may include a third annular connection portion, a pleated portion, and a fourth annular connection portion which are integrally connected. The third annular connection portion may be connected with a side of the second annular connection portion away from the coil. The fourth annular connection portion may be connected with the basket through a reinforcement member. The pleated portion may protrude in a direction away from the lead wire.

One or more embodiments of the present disclosure provide an electronic device. The electronic device may comprise the loudspeaker described above.

The beneficial effects of the present disclosure include that compared with the related art, the loudspeaker provided by the present disclosure is conducive to improving the technical problem of stress concentration in the lead wire by setting the ratio of the length of the lead wire of the coil to the maximum amplitude of the movement of the coil relative to the basket to be in the range of 8-75. If the ratio is too small, it may cause the amplitude of the second end of the lead wire away from the annular body to be relatively large, which is liable to cause the lead wire to break or desolder at the soldering pad. If the ratio is too large, it may cause the lead wire to excessively pull the second end due to excessive weight and over-deform towards the basket, which is liable to cause the lead wire to break or desolder at the soldering pad and collide with the basket, and also cause the overall size of the loudspeaker, not facilitating product miniaturization.

### BRIEF DESCRIPTION OF THE DRAWINGS

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to obtain other drawings in accordance with these drawings without creative labor.

FIG. 1 is a schematic diagram illustrating a front contour of an ear of a user according to some embodiments of the present disclosure;

FIG. 2 is a schematic structural diagram illustrating an exemplary earphone according to some embodiments of the present disclosure;

FIG. 3 is a schematic diagram illustrating the exemplary earphone in FIG. 2 in a wearing state;

FIG. 4 is a schematic structural diagram illustrating the exemplary earphone in FIG. 2 from a viewing angle;

FIG. 5 is a schematic structural diagram illustrating the exemplary earphone in FIG. 2 from another viewing angle;

FIG. 6 is a schematic structural diagram illustrating the exemplary earphone in FIG. 2 from still another viewing angle;

FIG. 7 is a schematic structural diagram illustrating an exemplary auxiliary structure according to some embodiments of the present disclosure;

FIG. 8 is a schematic structural diagram illustrating an exemplary earphone according to some embodiments of the present disclosure;

FIG. 9 is a schematic structural diagram illustrating the exemplary earphone in FIG. 8 from a viewing angle;

FIG. 10 is a schematic structural diagram illustrating the exemplary earphone in FIG. 8 from another viewing angle;

FIG. 11 is a schematic structural diagram illustrating an exemplary earphone according to some embodiments of the present disclosure;

FIG. 12 is a schematic diagram illustrating a comparison of frequency response curves measured at the same listening position when a core module of an exemplary earphone is located at different positions of an ear according to some embodiments of the present disclosure;

FIG. 13 is a schematic structural diagram illustrating a cross section of the exemplary earphone in FIG. 10 along a B1-B1 direction;

FIG. 14 is a schematic structural diagram illustrating exemplary core housing according to some embodiments of the present disclosure;

FIG. 15 is a schematic structural diagram illustrating exemplary core housing according to some embodiments of the present disclosure;

FIG. 16 is a schematic structural diagram illustrating an exemplary support according to some embodiments of the present disclosure;

FIG. 17 is a schematic structural diagram illustrating an enlargement of the exemplary earphone in FIG. 13 in a C1 region;

FIG. 18 is a schematic structural diagram illustrating an enlargement of the exemplary earphone in FIG. 13 in a C2 region;

FIG. 19 is a schematic diagram illustrating an exploded structure of an exemplary loudspeaker according to some embodiments of the present disclosure;

FIG. 20 is a schematic diagram illustrating a cross section of the exemplary loudspeaker in FIG. 19 along a B2-B2 direction;

FIG. 21 is a schematic diagram illustrating a cross section of the exemplary loudspeaker in FIG. 19 along a B3-B3 direction;

FIG. 22 is a schematic structural diagram illustrating an enlargement of the exemplary loudspeaker in FIG. 21 in a C3 region;

FIG. 23 is a schematic diagram of a partial structure of the exemplary loudspeaker in FIG. 19;

FIG. 24 is a schematic diagram illustrating a cross section of an exemplary basket in FIG. 19 along a B2-B2 direction; and

FIG. 25 is a schematic diagram illustrating an exploded structure of an exemplary basket in FIG. 19.

### DETAILED DESCRIPTION

The present disclosure is further described in detail below with reference to the accompanying drawings and embodiments. It is particularly noted that the following embodiments are only used to illustrate the present disclosure, but are not intended to limit the scope of the present disclosure. Similarly, the following embodiments are only some embodiments of the present disclosure rather than all embodiments, and all other embodiments obtained by a person of ordinary skill in the art without creative labor are within the scope of protection of the present disclosure

Reference to “embodiment” in the present disclosure means that a specific feature, structure or characteristic described with reference to the embodiment may be included in at least one embodiment of this application. It is explicitly and implicitly understood by those skilled in the art that the embodiment described in this application may be combined with other embodiments.

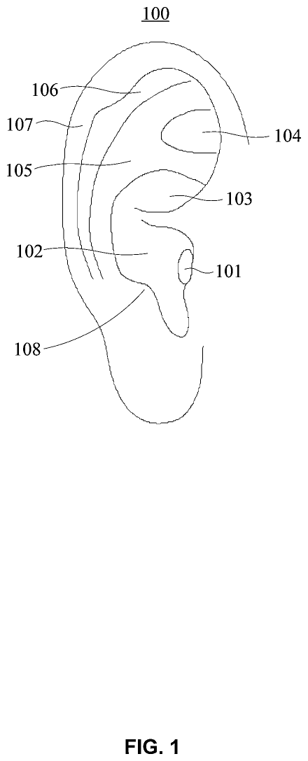

Referring to FIG. 1, an ear 100 of a user may include physiological parts such as an external ear canal 101, a cavity of auricular concha 102, a cymba conchae 103, a triangular fossa 104, an antihelix 105, a scapha 106, a helix 107, an antitragus 108, etc. Although the external ear canal 101 has a certain depth and extends to an eardrum of the ear, for the convenience of description and with reference to FIG. 1, the external ear canal 101 specifically refers to an entrance of the ear away from the eardrum (e.g., an ear hole) in the present disclosure unless otherwise specified. Further, the physiological parts, such as the cavity of auricular concha 102, the cymba conchae 103, the triangular fossa 104, etc., have a certain volume and depth; and the cavity of auricular concha 102 is directly connected with the external ear canal 101. That is, the ear hole is located at a bottom of the cavity of auricular concha 102.

Furthermore, different users may have individual differences, resulting in different shapes, sizes, and other dimensional differences in the ears. For the convenience of description, and to reduce (or even eliminate) the individual differences between different users, a simulator containing a head and (left and right) ears, such as GRAS 45BC KEMAR, may be made based on ANSI: S3.36, S3.25 and IEC: 60318-7 standards. Therefore, in the present disclosure, descriptions such as “a user wears the earphone”, “the earphone is in a wearing state” and “in a wearing state” refer to the earphone described in the present disclosure being worn on the ears of the simulator. Precisely because different users have individual differences, there may be certain differences between a situation that the earphone is worn by different users and a situation that the earphone is worn on the ears of the simulator. However, such differences should be tolerated.

It should be noted that in the fields of medicine and anatomy, three basic planes including a sagittal plane, a coronal plane, and a horizontal plane, and three basic axes including a sagittal axis, a coronal axis, and a vertical axis of a human body may be defined. The sagittal plane refers to a section perpendicular to the ground along front and rear directions of the body, which divides the human body into a left part and a right part. The coronal plane refers to a section perpendicular to the ground along left and right directions of the body, which divides the human body into a front part and a rear part. The horizontal plane refers to a section parallel to the ground along a vertical direction of the body, which divides the human body into an upper part and a lower part. Correspondingly, the sagittal axis refers to an axis along a front-back direction of the body and perpendicular to the coronal plane. The coronal axis refers to an axis along a left-right direction of the body and perpendicular to the sagittal plane. The vertical axis refers to an axis along a vertical direction of the body and perpendicular to the horizontal plane. Further, “the front side of the ear” as used in the present disclosure is relative to “the rear side of the ear”. “The front side of the ear” in the present disclosure refers to a side of the ear away from the head, and “the rear side of the ear” refers to a side of the ear facing the head. Both “the front side of the ear” and “the rear side of the ear” are described with respect to the ear of the user. A schematic diagram illustrating a front contour of the ear as shown in FIG. 1 may be obtained by observing the ear of the simulator along the coronal axis direction of the human body.

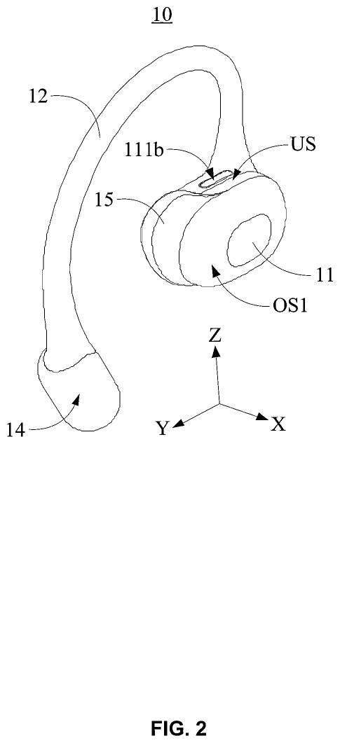

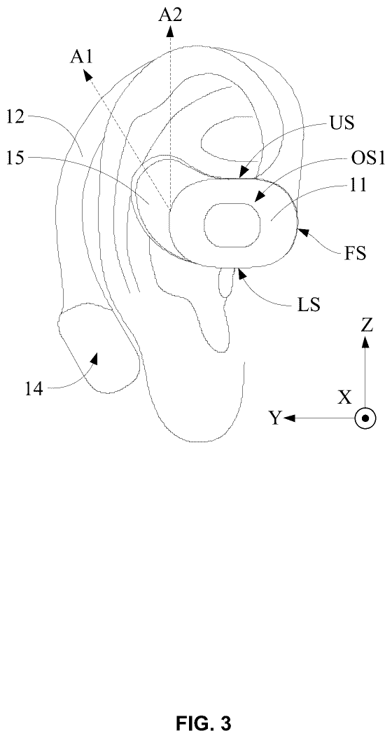

As an example, referring to FIG. 2 and FIG. 3, an earphone 10 may include a core module 11 and a hook structure 12 connected with the core module 11. The core module 11 may be located on a front side of the ear in a wearing state. At least a portion of the hook structure 12 may be located at a rear side of the ear in the wearing state, such that the earphone 10 may be hung on the ear in the wearing state. The core module 11 may be configured not to block an external ear canal in the wearing state, such that the earphone 10 may be used as an “open earphone”. It is worth noting that due to individual differences among different users, when the earphone 10 is worn by different users, the core module 11 may partially cover the external ear canal, but the external ear canal is still not blocked.

In order to improve the stability of the earphone 10 in the wearing state, the earphone 10 may adopt any one of the following modes or a combination thereof. Firstly, at least a portion of the hook structure 12 may be configured as a conformal structure that fits at least one of the rear side of the ear and the head, to increase a contact area between the hook structure 12 and the ear and/or the head, thereby increasing the resistance of the earphone 10 to fall off the ear. Secondly, at least a portion of the hook structure 12 may be configured as an elastic structure such that the hook structure 12 may have a certain amount of deformation in the waring state, to increase a positive pressure of the hook structure 12 on the ear and/or the head, thereby increasing the resistance of the earphone 10 to fall off the ear. Thirdly, at least a portion of the hook structure 12 may be configured to abut against the head in the wearing state to form a reaction force that presses the ear, such that the core module 11 is pressed on the front side of the ear, thereby increasing the resistance of the earphone 10 to fall off the ear. Fourthly, the core module 11 and the hook structure 12 may be configured to clamp the physiological parts such as a region where the antihelix is located and a region where the cavity of auricular concha is located from the front and back sides of the ear in the wearing state, thereby increasing the resistance of the earphone 10 to fall off the ear. Fifthly, the core module 11 or an auxiliary structure connected therewith may be configured to at least partially extend into the physiological parts such as the cavity of auricular concha, the cymba conchae, the triangular fossa, the scapha, etc., thereby increasing the resistance of the earphone 10 to fall off the ear.

As an example, referring to FIGS. 1-3, the earphone 10 may include an auxiliary structure 15 connected with the core module 11. At least a portion of the auxiliary structure 15 may be located on the front side of the ear in the wearing state. That is, at least a portion of the auxiliary structure 15 and the core module 11 may be located on the same side of the ear in the wearing state, to assist the core module 11 in the wearing state. In the wearing state, the core module 11 may be pressed on a first ear region corresponding to the cymba conchae, and the auxiliary structure 15 may be pressed on a second ear region corresponding to the antihelix. That is, the core module 11 and the auxiliary structure 15 may be pressed on different regions of the ear. In this way, compared with the earphone 10 only having the core module 11, the earphone 10 is further provided with the auxiliary structure 15 cooperating with the core module 11, which increases a contact area between the earphone 10 and the front side of the ear, and avoids a force between the earphone 10 and the front side of the ear being concentrated in a relatively small region, thereby improving the stability and comfort of the earphone 10 in the wearing state. In addition, in a thickness direction of the core module 11, an offset distance between the auxiliary structure 15 and the hook structure 12 may be less than an offset distance between the core module 11 and the hook structure 12, such that a shear stress generated by a clamping force of the earphone 10 on the ear may be weakened, or even converted into a compressive stress, which improves the stability and comfort of the earphone 10 in the wearing state. A thickness direction X may be defined as a direction in which the core module 11 is close to or away from the ear in the wearing state.

In some embodiments, the auxiliary structure 15 may be detachably connected with the core module 11 through any of a buckle, a double-sided adhesive tape, threads, etc. A plurality of auxiliary structures 15 of the same or different specifications may be prepared for the earphone 10 to facilitate replacement or use by different users.

In some embodiments, referring to FIG. 3, in the wearing state and in the thickness direction X, an extension direction (e.g., a dotted arrow A1 in FIG. 3) of the auxiliary structure 15 may point to the back of the head, and an angle between the extension direction of the auxiliary structure 15 and a positive direction (e.g., a dotted arrow A2 in FIG. 3) of the vertical axis of the human body pointing to the top of the head may be an acute angle. In this way, the auxiliary structure 15 may be pressed on an ear region corresponding to the antihelix, and the auxiliary structure 15 may also be pressed on a middle region of the antihelix with a relatively large area, which improves the stability and comfort of the earphone 10 in the wearing state.

In some embodiments, referring to FIGS. 2-6, the core module 11 may be provided with a first inner side surface IS1 facing the ear and a first outer side surface OS1 away from the ear along the thickness direction X in the wearing state, and a connection surface connecting the first inner side surface IS1 and the first outer side surface OS1. The auxiliary structure 15 may be connected with at least the connection surface. For example, the auxiliary structure 15 may be only connected with the connection surface. As another example, the auxiliary structure 15 may be connected with the connection surface and the first outer side surface OS1. In this way, a distance between the auxiliary structure 15 and the hook structure 12 in the thickness direction X may be controlled to be within a reasonable range, and a large pressing force at the auxiliary structure 15 caused by a too small distance or a small pressing force at the auxiliary structure 15 caused by a too large distance may be avoided.

It should be noted that in the thickness direction X, the core module 11 may be configured as a circle, an ellipse, a rounded square, a rounded rectangle, etc. When the core module 11 is configured as a circle, an ellipse, etc., the connection surface refers to an arc side surface of the core module 11; and when the core module 11 is configured as a rounded square, rounded rectangle, etc., the connection surface may include a lower side surface LS, an upper side surface US, a front side surface FS, and a rear side surface RS described in the present disclosure. In some embodiments, the core module 11 may have a length direction Y and a width direction Z which are perpendicular to the thickness direction X and orthogonal to each other. The length direction Y may be defined as a direction in which the core module 11 is close to or away from the back of the head of the user in the wearing state. The width direction Z may be defined as a direction in which the core module 11 is close to or away from the top of the head of the user in the wearing state. Therefore, for the convenience of description, the present disclosure takes the core module 11 as a rounded rectangle as an example for exemplary description. A length of the core module 11 in the length direction Y may be greater than a width of the core module 11 in the width direction Z. Accordingly, the connection surface may include the upper side surface US away from the external ear canal along the width direction Z and the lower side surface LS facing the external ear canal in the wearing state, and the rear side surface RS facing the back of the head and the front side surface FS away from the back of the head along the length direction Y in the wearing state. The auxiliary structure 15 may be connected with at least the rear side surface RS. For example, the auxiliary structure 15 may be only connected with the rear side surface RS. As another example, the auxiliary structure 15 may be connected with the rear side surface RS and the upper side surface US. In this way, the auxiliary structure 15 may be mainly pressed on the middle region of the antihelix with a relatively large area.

In some embodiments, a thickness of the auxiliary structure 15 may be less than a size of the core module 11 in the thickness direction, to consider the weight and size of the earphone 10. In the length direction Y or the width direction Z, a position where the auxiliary structure 15 is connected with the core module 11 may be located between a position of one-third of the thickness of the core module 11 in the thickness direction X and a position of two-thirds of the thickness of the core module 11 in the thickness direction X. For example, the position where the auxiliary structure 15 is connected with the core module 11 may be located at a position of one-half of the thickness of the core module 11 in the thickness direction X. In this way, the distance between the auxiliary structure 15 and the hook structure 12 in the thickness direction X may be controlled to be within a reasonable range, and a large pressing force at the auxiliary structure 15 caused by the too small distance or a small pressing force at the auxiliary structure 15 caused by the too large distance may be avoided.

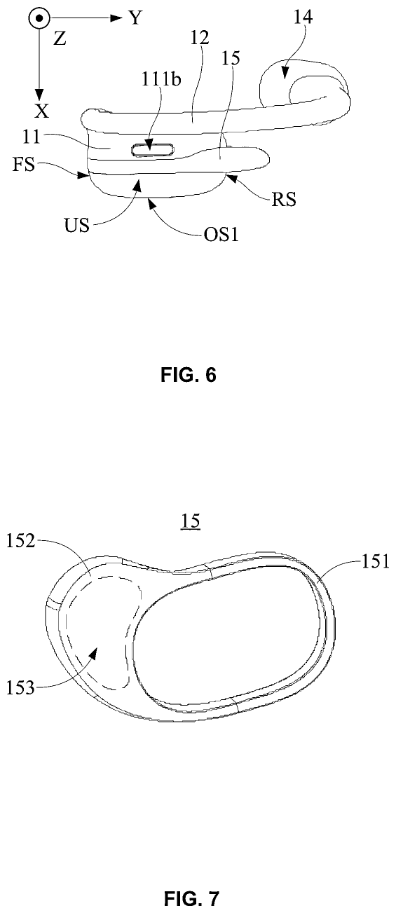

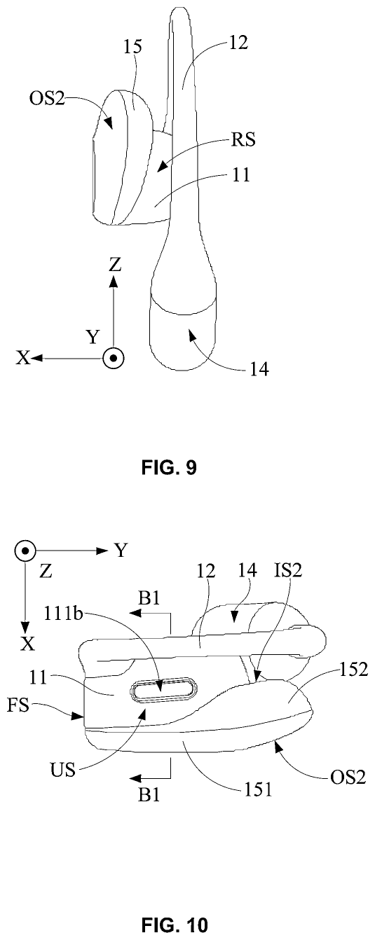

In some embodiments, referring to FIG. 5, FIG. 6, FIG. 9, and FIG. 10, the hook structure 12 and the auxiliary structure 15 may be staggered in the thickness direction X. In this way, the earphone 10 may better adapt to the thickness of the ear, which avoids discomfort in wearing caused by a too large pressing force of the auxiliary structure 15 at the antihelix, and avoids wearing instability caused by the auxiliary structure 15 lifting the core module 11.

As an example, referring to FIG. 7, the auxiliary structure 15 may include a connection portion 151 connected with the core module 11 and an extension portion 152 connected with the connection portion 151. The auxiliary structure 15 may contact the antihelix through the extension portion 152. A hardness of the extension portion 152 may be less than a hardness of the core module 11. For example, a material of the extension portion 152 may include plastic, rubber, etc. In this way, the extension portion 152 may undergo different elastic deformations when the earphone 10 is worn by different users to make the pressing force of the auxiliary structure 15 at the antihelix appropriate. A hardness of the connection portion 151 may be less than the hardness of the core module 11 (specifically, a core housing 111 described below). For example, a material of the connection portion 151 may be the same as that of the extension portion 152. Accordingly, the connection portion 151 and the core module 11 may be configured to be detachably connected or non-detachably connected according to needs.

In some embodiments, the auxiliary structure 15 may include a flexible insert 153 connected with the extension portion 152. The flexible insert 153 may be arranged inside the extension portion 152 or on a side of the extension portion 152 facing the antihelix. A hardness of the flexible insert 153 may be less than the hardness of the extension portion 152, such that a portion of the auxiliary structure 15 in contact with the antihelix is softer, which improves the stability and comfort of the earphone 10 in the wearing state.

In some embodiments, referring to FIG. 5 and FIG. 6, the connection surface may be provided with a mounting groove extending along a circumferential direction of the core module 11, and the connection portion 151 may be fixed in the mounting groove. The mounting groove may be arranged in an annular shape. The connection portion 151 may also be arranged in an annular structure (e.g., as shown in FIG. 7) that matches the mounting groove, and the connection portion 151 may be embedded in the mounting groove. The mounting groove may also be arranged in a C-shape or a U-shape. For example, the mounting groove may be arranged on the rear side surface RS and extend to the lower side surface LS and the upper side surface US. The connection portion 151 may also be arranged in a C-shape or a U-shape structure that matches the mounting groove, and the connection portion 151 may be embedded in the mounting groove.

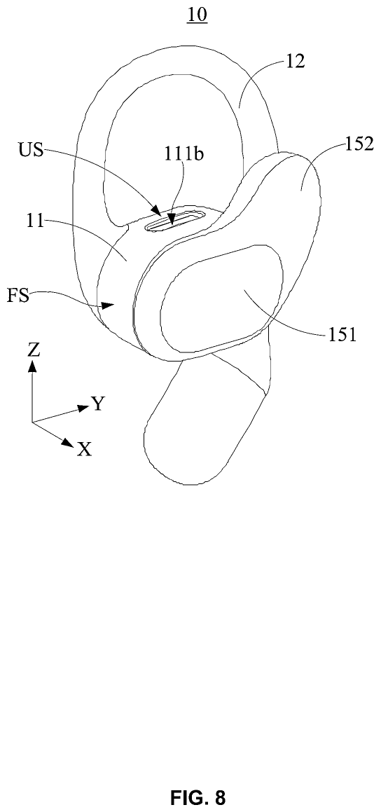

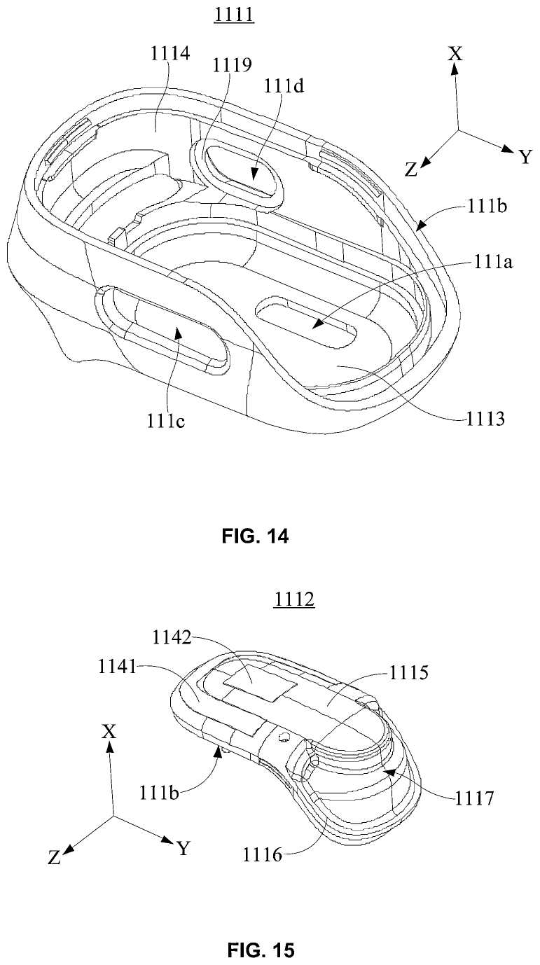

In some embodiments, referring to FIGS. 8-10, the connection portion 151 may cover at least a portion of the first outer side surface OS1. For example, the first outer side surface OS1 may be completely covered by the connection portion 151. That is, the first outer side surface OS1 shown in FIGS. 2-6 is not visible in FIGS. 8-10. In this way, a connection area between the connection portion 151 and the core module 11 may be increased, and the connection portion 151 and the core module 11 may also be connected by bonding, injection molding, etc. The extension portion 152 may have a second inner side surface IS2 facing the antihelix and a second outer side surface OS2 away from the antihelix in the wearing state. At least one of the second inner side surface IS2 and the second outer inner side surface OS2 may be inclined towards the antihelix in the extension direction of the auxiliary structure 15. For example, the second inner side surface IS2 and the second outer inner side surface OS2 may both be inclined towards the antihelix in the extension direction of the auxiliary structure 15. For example, the extension portion 152 may be bent towards the first inner side surface IS1 relative to the connection portion 151. In this way, the extension portion 152 may better contact the antihelix, and the thickness of the extension portion 152 may be considered. In some embodiments, referring to FIG. 14 and FIG. 15, the connection portion 151 may cover at least a portion of the connection surface (e.g., the rear side surface RS) in addition to covering at least a portion of the first outer side surface OS1. In this way, the connection area between the connection portion 151 and the core module 11 may be increased, the comfort of the core module 11 in contact with the ear at the rear side surface RS may be improved.

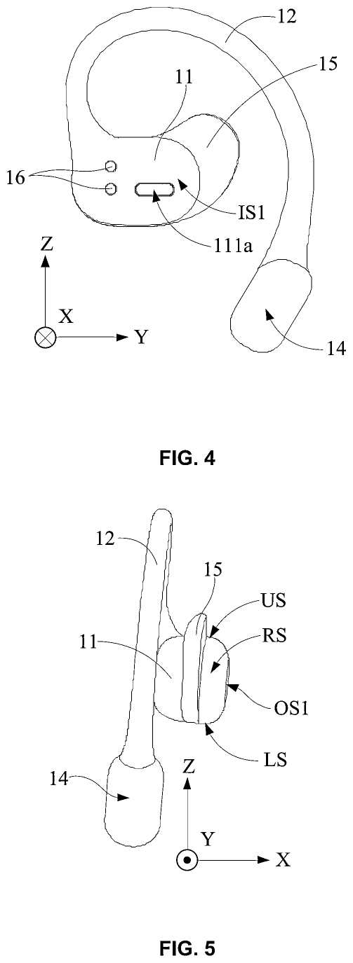

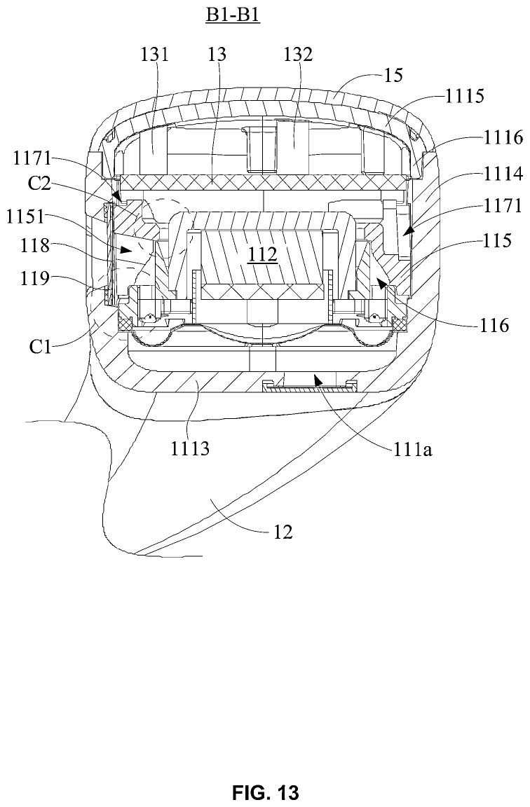

As an example, referring to FIG. 4 and FIG. 13, the core module 11 may include a core housing 111 connected with the hook structure 12 and a loudspeaker 112 disposed in the core housing 111. An inner side surface (e.g., the first inner side surface IS1 described above) of the core housing 111 facing the ear in the wearing state may be provided with a sound guiding hole 111a, and sound waves generated by the loudspeaker 112 may be propagated through the sound guiding hole 111a to be transmitted into the external ear canal. It should be noted that the sound guiding hole 111a may also be provided on a side of the core housing 111 corresponding to the lower side surface LS, and may also be provided at a corner between the inner side surface and the lower side surface LS.

In some embodiments, referring to FIG. 13 and FIGS. 2-11, the earphone 10 may include a main control circuit board 13 disposed in the core housing 111 and a battery 14 disposed at an end of the hook structure 12 away from the core module 11. The battery 14 and the loudspeaker 112 may be respectively coupled to the main control circuit board 13 to allow the battery 14 to power the loudspeaker 112 under the control of the main control circuit board 13. In some embodiments, the battery 14 and the loudspeaker 112 may be disposed in the core housing 111.

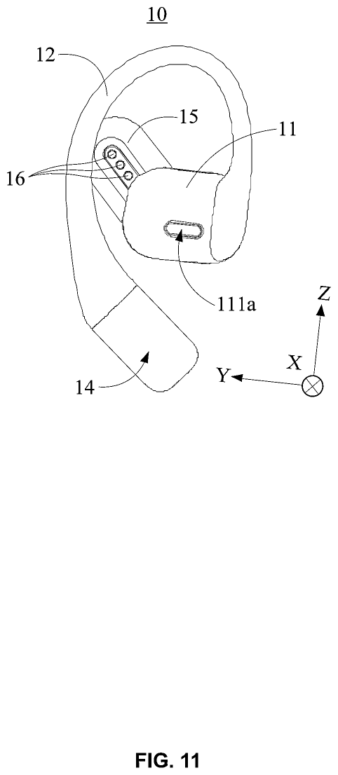

In some embodiments, referring to FIG. 4 or FIG. 11, an inner side of the core housing 111 or the auxiliary structure 15 (specifically, the extension portion 152) facing the ear in the wearing state may be provided with an electrode terminal 16. The electrode terminal 16 may be coupled with the main control circuit board 13. Two electrode terminals 16 may be provided and respectively configured as a positive charging terminal and a negative charging terminal of the earphone 10, such that the earphone 10 may realize the charging function. Three electrode terminals 16 may be provided, where two of the three electrode terminals 16 may be respectively configured as the positive charging terminal and the negative charging terminal of the earphone 10, and the remaining of the three electrode terminals 16 may be configured as a detection terminal of the earphone 10, such that the earphone 10 may realize the detection functions such as charging detection and detection of the earphone 10 being placed in or taken out of a charging box.

In some embodiments, referring to FIG. 3 and FIG. 1, since the cymba conchae and the cavity of auricular concha connected therewith have a certain volume and depth, after the core module 11 is pressed on an ear region corresponding to the antihelix, a certain distance is formed between the inner side surface (e.g. the first inner side surface IS1 described above) of the core housing 111 and the cymba conchae and the cavity of auricular concha. In other words, the core module 11 may cooperate with the cymba conchae and the cavity of auricular concha to form an auxiliary cavity connected with the external ear canal in the wearing state, and the sound guiding hole 111a may be at least partially located in the auxiliary cavity. In this way, in the wearing state, the sound waves generated by the loudspeaker 112 and propagated through the sound guiding hole 111a may be restricted by the auxiliary cavity. That is, the auxiliary cavity may gather the sound waves such that the sound waves may be propagated much into the external ear canal, thereby increasing the volume and sound quality of a sound heard by the user in a near field, and improving the acoustic effect of the earphone 10. Furthermore, since the core module 11 may be configured not to block the external ear canal in the wearing state, the auxiliary cavity may be configured in a semi-open manner. In this way, in addition to being mostly propagated to the external ear canal, a small portion of the sound waves generated by the loudspeaker 112 and propagated through the sound guiding hole 111a, may be propagated to the outside of the earphone 10 and the ear through a gap between the core module 11 and the ear (e.g., a portion of the cavity of auricular concha not covered by the core module 11), thereby forming a first sound leakage in a far field. Meanwhile, the core module 11 is generally provided with an acoustic hole (e.g., a pressure relief hole 111c described below), and the sound waves propagated through the acoustic hole generally form a second sound leakage in the far field, and a phase of the first sound leakage and a phase of the second sound leakage is (approximately) opposite to each other, such that the first sound leakage and the second sound leakage can cancel each other out in opposite phases in the far field, thereby reducing the sound leakage of the earphone 10 in the far field.

In some embodiments, the earphone 10 may include an adjustment mechanism connecting the core module 11 and the hook structure 12. Different users may adjust a relative position of the core module 11 on the ear through the adjustment mechanism in the wearing state, so that the core module 11 is located at an appropriate position, and the core module 11, the cymba conchae, and the cavity of auricular concha form the auxiliary cavity. In addition, due to the arrangement of the adjustment mechanism, the user may also adjust the earphone 10 to a stable and comfortable position.

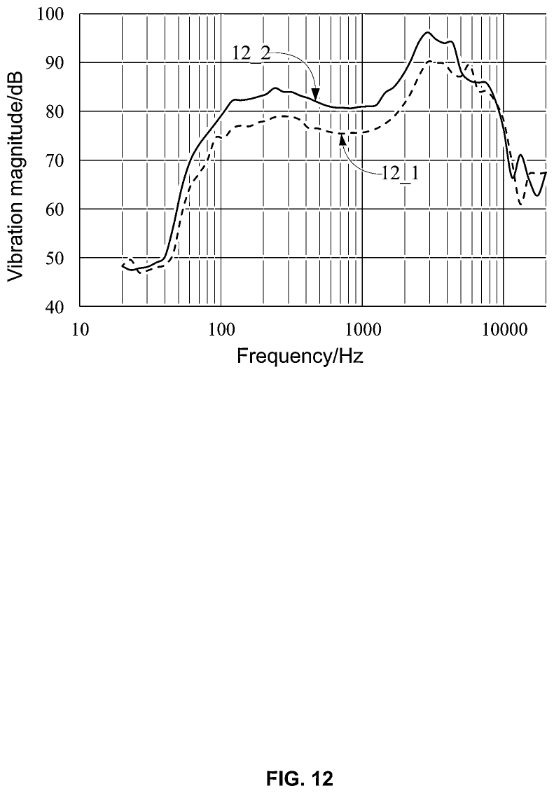

In some embodiments, referring to FIG. 12, the earphone 10 may be first worn on the simulator, then the position of the core module 11 on the ear of the simulator may be adjusted, and then a frequency response curve of the earphone 10 may be measured by a detector (e.g., a microphone) disposed in the external ear canal (e.g., the position of the eardrum such as a listening position) of the simulator, thereby simulating the listening effect when the user wears the earphone 10. The frequency response curve may be used to characterize a changing relationship between a vibration magnitude and a frequency. An abscissa of the frequency response curve represents the frequency in Hz; and an ordinate of the frequency response curve represents the vibration magnitude in dB. In FIG. 12, a curve 12_1 represents a frequency response curve when the core module 11 does not form the auxiliary cavity with the cavity of auricular concha in the wearing state, and a curve 12_2 represents a frequency response curve when the core module 11 cooperates with the cavity of auricular concha to form the auxiliary cavity in the wearing state. Accordingly, it may be directly and undoubtedly concluded from a comparison diagram of the frequency response curves shown in FIG. 12 that the curve 12_2 is generally located above the curve 12_1. That is, compared with the situation where the core module 11 does not form the auxiliary cavity with the cavity of auricular concha in the wearing state, the situation that the core module 11 cooperates with the cavity of auricular concha to form the auxiliary cavity in the wearing state is conducive to improving the acoustic effect of the earphone 10.

In some embodiments, referring to FIG. 14 and FIG. 15, the core housing 111 may include a core inner housing 1111 and a core outer housing 1112 which are buckled together along the thickness direction X. The core inner housing 1111 is closer to the ear than the core outer housing 1112 in the wearing state. A parting surface 111b between the core outer housing 1112 and the core inner housing 1111 may be inclined towards a side where the core inner housing 1111 is located in a direction (e.g., a direction indicated by an arrow Y in FIG. 14) of an end (hereinafter referred to as a “connection end”) away from a connection between the core module 11 and the hook structure 12. In this way, the connection portion 151 may be mainly connected with the core outer housing 1112, which increases a connection area between the auxiliary structure 15 and the core module 11 without increasing a size of the core module 11 in the length direction Y, and simplifies a connection structure between the auxiliary structure 15 and the core module 11.

In some embodiments, referring to FIG. 14 and FIG. 15, the core inner housing 1111 may include a bottom wall 1113 and a first sidewall 1114 connected with the bottom wall 1113, and the core outer housing 1112 may include a top wall 1115 and a second sidewall 1116 connected with the top wall 1115. The second sidewall 1116 and the first sidewall 1114 may be buckled with each other along the parting surface 111b, and the second sidewall 1116 and the first sidewall 1114 may support each other. In the width direction Z and in the length direction Y (specifically a positive direction indicated by the arrow Y in FIG. 14 and FIG. 15), a portion of the first sidewall 1114 away from the connection end may be gradually close to the bottom wall 1113 in the thickness direction X, and a portion of the second sidewall 1116 away from the connection end may be gradually away from the top wall 1115 in the thickness direction X, such that the parting surface 111b may be inclined towards the side where the core inner housing 1111 is located in the direction away from the connection end. Correspondingly, the sound guiding hole 111a may be disposed on the bottom wall 1113. The sound guiding hole 111a may also be disposed on a side of the first sidewall 1114 corresponding to the lower side surface LS, or may be disposed at a corner between the first sidewall 1114 and the bottom wall 1113.

Furthermore, the core outer housing 1112 may be provided with an embedding groove 1117 which is at least partially located on the second sidewall 1116. The auxiliary structure 15 may be partially embedded in the embedding groove 1117, such that a continuous transition may be formed between an outer surface of a region of the core inner housing 1111 not covered by the auxiliary structure 15 and an outer surface of the auxiliary structure 15, which improves the continuity of the appearance of the earphone 10.

In some embodiments, referring to FIG. 14, the core housing 111 may be provided with a pressure relief hole 111c. The pressure relief hole 111c makes a space on a side of the loudspeaker 112 facing the main control circuit board 13 be connected to an external environment. For example, the air may freely enter and exit the space, thereby reducing the resistance of the diaphragm of the loudspeaker 112 during a vibration process. The pressure relief hole 111c may face the top of the head in the wearing state, which prevents the sound waves propagated through the pressure relief hole 111c from forming a sound leakage (e.g., the second sound leakage) being heard. According to the Helmholtz resonator, an aperture of the pressure relief hole 111c may be as large as possible, such that a resonance frequency of the second sound leakage is shifted to a high frequency band (e.g., a frequency range greater than 4 kHz) as much as possible, which further prevents the second sound leakage from being heard.

In some embodiments, the core housing 111 may be provided with a tuning hole 111d. The tuning hole 111d makes the resonance frequency of the second sound leakage shift to a high frequency band (e.g., a frequency range greater than 4 kHz) as much as possible, which further prevents the second sound leakage from being heard. An area of the tuning hole 111d may be less than an area of the pressure relief hole 111c, such that the space on the side of the loudspeaker 112 facing the main control circuit board 13 is connected to the external environment through the pressure relief hole 111c. In some embodiments, a distance between the sound guiding hole 111a and the pressure relief hole 111c in the width direction Z may be greater than a distance between the sound guiding hole 111a and the tuning hole 111d in the width direction Z, so as to avoid the sound waves propagated through the sound guiding hole 111a and the pressure relief hole 111c respectively from cancelling out in opposite phases in the near field, thereby improving the volume of the sound propagated through the sound guiding hole 111a and heard by the user. Accordingly, a distance between the tuning hole 111d and the sound guiding hole 111a in the length direction Y may be reasonably designed according to actual needs.

In some embodiments, referring to FIG. 14, the sound guiding hole 111a, the pressure relief hole 111c, and the tuning hole 111d may be disposed on the core inner housing 1111. For example, the sound guiding hole 111a may be disposed on the bottom wall 1113, and the pressure relief hole 111c and the tuning hole 111d may be disposed on the first sidewall 1114. The pressure relief hole 111c and the tuning hole 111d may be respectively disposed on opposite sides of the first sidewall 1114 along the width direction Z. In this way, since the sound guiding hole 111a, the pressure relief hole 111c, and the tuning hole 111d are all disposed on the core inner housing 1111, the structure of the core outer housing 1112 is simple, which reduces the processing cost. In addition, since the pressure relief hole 111c and the tuning hole 111d are respectively disposed on the opposite sides of the first sidewall 1114 along the width direction Z, the parting surface 111b may be symmetrically arranged with reference to a reference plane perpendicular to the width direction Z, thereby improving the appearance quality of the core module 11.

In some embodiments, referring to FIG. 15, the core module 11 may include at least one of an antenna pattern 1141 or a touch pattern 1142 disposed between the core housing 1112 and the auxiliary structure 15 (e.g., the connection portion 151), and other metal functional patterns. The antenna pattern 1141 may be formed on an outer side of the core housing 1112 through laser direct structuring (LDS). The touch pattern 1142 may be formed on the outer side of the core housing 1112 through LDS, or may be a flexible touch circuit board adhered to the outer side of the core housing 1112. In some embodiments, the core housing 1112 may be provided with a metallized hole connected with the antenna pattern 1141 and the touch pattern 1142, respectively. In this case, since the main control circuit board 13 is disposed in the core housing 111 (e.g., the main control circuit board 13 is connected with the core housing 1112), the main control circuit board 13 may contact an inner wall of the corresponding metallized hole through pogo-PIN, a metal spring, and other elastic metal parts. The antenna pattern 1141 and the touch pattern 1142 may be respectively connected with a pogo-PIN 131 and a pogo-PIN 132 welded on the main control circuit board 13. Accordingly, the loudspeaker 112 may be located on a side of the main control circuit board 13 away from the core housing 1112. In this way, compared with the situation that the antenna pattern 1141 and the touch pattern 1142 are disposed on the inner side of the core housing 1112 facing the loudspeaker 112, the antenna pattern 1141 is disposed on the outer side of the core housing 1112 to increase a distance between the antenna pattern 1141 and the main control circuit board 13, that is, to increase an antenna clearance region, thereby increasing the anti-interference performance of the antenna pattern 1141. The touch pattern 1142 is on the outer side of the core housing 1112 to reduce a distance between the touch pattern 1142 and an external signal trigger source (e.g., a finger of the user), that is, to reduce a touch distance, thereby increasing the sensitivity of the touch pattern 1142 being triggered by the user.

In some embodiments, the antenna pattern 1141 may surround the periphery of the touch pattern 1142 to fully utilize a space of the outer side of the core housing 1112. The antenna pattern 1141 may be arranged in a U-shape, and the touch pattern 1142 may be arranged in a square shape. Accordingly, the antenna pattern 1141 and the touch pattern 1142 and the respective metallized holes may be arranged on the top wall 1115.

In some embodiments, referring to FIG. 13, the core module 11 may include a support 115 disposed in the core housing 111. The support 115 and the loudspeaker 112 may be enclosed to form an acoustic cavity 116, such that the acoustic cavity 116 is separated from other structures (e.g., the main control circuit board 13, etc.) in the core housing 111, which improves the acoustic performance of the core module 11. The core housing 111 may be provided with an acoustic hole. For example, the acoustic hole may be at least one of the pressure relief hole 111c and the tuning hole 111d, and the support 115 may be provided with an acoustic channel 1151 connecting the acoustic hole and the acoustic cavity 116, such that the acoustic cavity 116 is connected to the external environment. That is, the air may freely enter and exit the acoustic cavity 116, thereby reducing the resistance of the diaphragm of the loudspeaker 112 during the vibration process.

In some embodiments, the support 115 may cooperate with the core housing 111 to form a first glue groove 1171 surrounding at least a portion of the acoustic hole. The first glue groove 1171 may contain a first glue for sealing an assembly gap between the support 115 and the core housing 111. That is, the first glue may be used to perform waterproof sealing, which prevents sweat, rain, and other liquid droplets from invading the space where the main control circuit board 13 is located in the core housing 111 from the outside. In this way, according to the Helmholtz resonator, compared with the related art that a silicone sleeve is pressed on the core housing 111 through the support 115 for waterproof sealing, the present technical solution performs waterproof sealing through the first glue, which may save the silicone sleeve in the related art, and shorten the length of a portion (including the acoustic channel 1151 and the acoustic hole) of the acoustic cavity 116 that is connected to the external environment, such that the resonance frequency of the sound leakage (e.g., the second sound leakage) formed by the sound waves propagated through the pressure relief hole 111c is shifted to a high frequency band (e.g., a frequency range greater than 4 kHz) as much as possible, thereby further preventing the second sound leakage from being heard.

It should be noted that when the acoustic hole is the pressure relief hole 111c, the first glue groove 1171 may surround at least a portion of the pressure relief hole 111c; when the acoustic hole is the tuning hole 111d, the first glue groove 1171 may surround at least a portion of the tuning hole 111d; when the acoustic hole is the pressure relief hole 111c and the tuning hole 111d, the first glue groove 1171 may surround at least a portion of the pressure relief hole 111c and the tuning hole 111d, respectively. For the convenience of description, referring to FIG. 14, the present disclosure is described with the acoustic hole being the pressure relief hole 111c and the tuning holes 111d, and the first glue groove 1171 surrounding at least a portion of the pressure relief hole 111c and the tuning hole 111d, respectively, as examples. In some embodiments, if a gap between the support 115 and the core housing 111 (e.g., the bottom wall 1113 of the core housing 111) is large enough, or the bottom wall 1113 and the first sidewall 1114 of the core housing 111 are not an integrally molded structure (e.g., the bottom wall 1113 and the first sidewall 1114 of the core housing 111 are two separate structures), the first glue groove 1171 may surround the entire acoustic hole. For example, the first glue groove 1171 may be a complete annular structure.

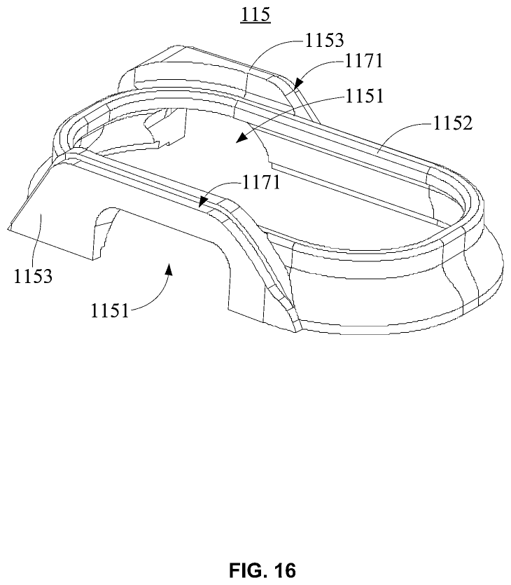

In some embodiments, referring to FIG. 16 and FIG. 13, the support 115 may include an annular body 1152 and a docking portion 1153 connected with the annular body 1152. The annular body 1152 may sleeve periphery of the loudspeaker 112 to form the acoustic cavity 116, and the acoustic channel 1151 may penetrate through the docking portion 1153 and the annular body 1152. In some embodiments, the docking portion 1153 may be located between the annular body 1152 and the core housing 111, and may surround at least a portion of the acoustic hole, and the docking portion 1153 may cooperate with the core housing 111 to form the first glue groove 1171. Since the acoustic hole may be the pressure relief hole 111c and the tuning hole 111d, two docking portions 1153 may be correspondingly provided, and two first glue grooves 1171 may be correspondingly provided. Correspondingly, the docking portion 1153 may cooperate with the first sidewall 1114 to form the first glue groove 1171. In this way, since the support 115 is arranged in an annular shape, the side of the loudspeaker 112 facing the main control circuit board 13 may be exposed, which reduces the thickness of the core module 11 in the thickness direction X.

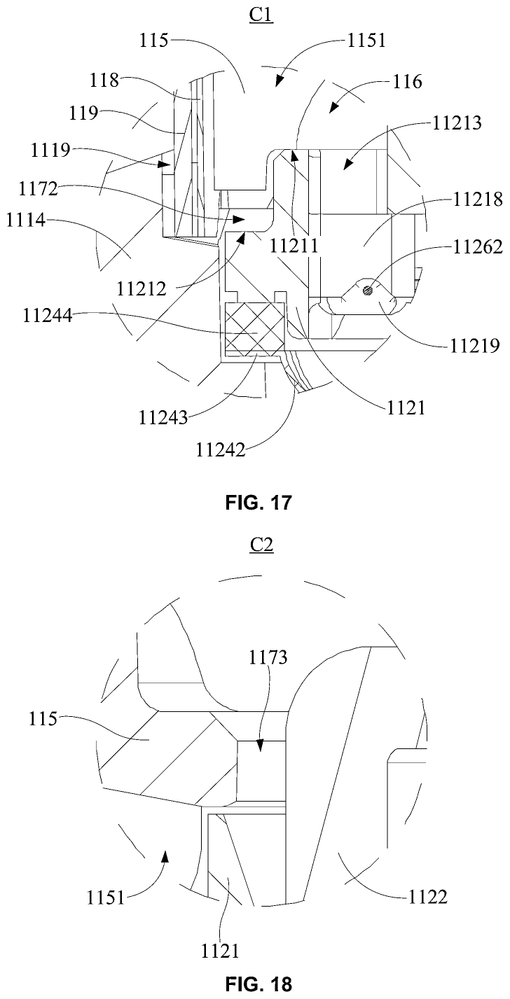

In some embodiments, referring to FIG. 17 and FIG. 14, a concave region 1119 may be disposed on an inner side of the core housing 111. The acoustic hole may be disposed at a bottom of the concave region 1119. The core module 11 may include an acoustic resistance net 118 disposed in the concave region 1119. The docking portion 1153 may press the acoustic resistance net 118 on the bottom of the concave region 1119. In this way, the support 115 is prevented from scraping the acoustic resistance net 118 during an assembly process, an assembly gap between the support 115, the acoustic resistance net 118, and the core inner housing 1111 is reduced, and the acoustic resistance net 118 is prevented from shaking. The acoustic resistance net 118 may be pre-fixed at the bottom of the concave region 1119 through a double-sided tape or glue. The acoustic resistance net 118 may be pre-fixed on a protective steel net 119, and then the protective steel net 119 may be pre-fixed at the bottom of the concave region 1119 through the double-sided tape or the glue. Correspondingly, since the acoustic hole may be the pressure relief hole 111c and the tuning hole 111d, two concave regions 1119 may be correspondingly provided, and two acoustic resistance nets 118 may be correspondingly provided.

In some embodiments, the first glue may be further used to seal at least one of an assembly gap between the support 115 and the acoustic resistance net 118 or an assembly gap between the acoustic resistance net 118 and the core housing 111 (e.g., a sidewall of the concave region 1119), thereby further facilitating waterproof sealing.

In some embodiments, referring to FIG. 13, FIG. 14 and FIG. 16, the docking portion 1153 may be configured to form a bottom wall and a groove wall of one side of the first glue groove 1171, and the core housing 111 may be configured to form a groove wall of the other side of the first glue groove 1171. The groove wall on the core housing 111 and the groove wall on the docking portion 1153 may be arranged opposite to each other, such that the first glue groove 1171 has a certain width and depth. The docking portion 1153 may be configured to form the groove wall of one side of the first glue groove 1171, and the core housing 111 may be configured to form the bottom wall and the groove wall of the other side of the first glue groove 1171; or the docking portion 1153 may be configured to form one portion of the groove wall of one side of the first glue groove 1171 and the bottom wall, and the core housing 111 may be configured to form the other portion of the groove wall of the other side of the first glue groove 1171 and the bottom wall.

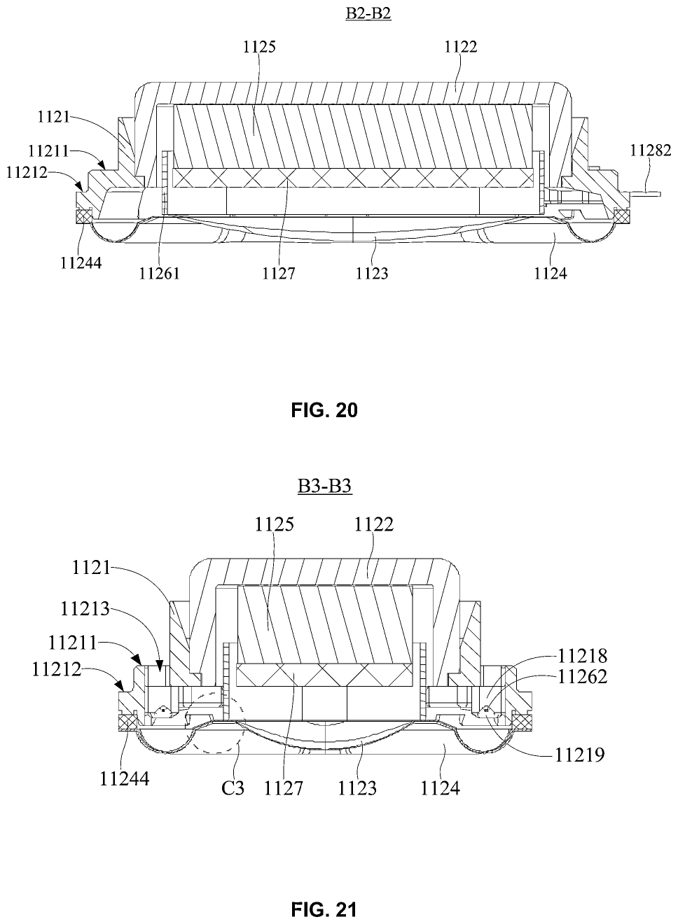

In some embodiments, referring to FIGS. 17-25, the loudspeaker 112 may include a basket 1121 and a magnetic shield 1122 connected with the basket 1121. A lower end of the support 115 may be supported on the basket 1121. A side of the acoustic channel 1151 facing the basket 1121 may be open. The basket 1121 may further block an open portion of the acoustic channel 1151. In this case, it may be simply regarded as that the first glue groove 1171 surrounds a portion of the acoustic hole, so as to facilitate filling glue in the first glue groove 1171 subsequently using a glue dispensing process, or the like.

In some embodiments, the loudspeaker 112 may include a diaphragm 1123 and a folded ring 1124. The folded ring 1124 may connect the diaphragm 1123 and the basket 1121. After the loudspeaker 112 is assembled in the core housing 111, the diaphragm 1123, the folded ring 1124, and the surrounding basket 1121 and the core housing 111 may prevent the sweat, rain, and other droplets that invade through the sound guiding hole 111a from penetrating into the space where the main control circuit board 13 is located in the core housing 111. Accordingly, the loudspeaker 112 may include a magnet 1125 disposed in the magnetic shield 1122 and a coil 1126 connected with the diaphragm 1123. The magnet 1125 and the magnetic shield 1122 may form a magnetic gap, and the coil 1126 may extend into the magnetic gap. The loudspeaker 112 may include a magnetic conductive plate 1127 disposed on a side of the magnet 1125 facing the diaphragm 1123. The magnetic conductive plate 1127, the magnetic shield 1122, and the coil 1126 may overlap in the vibration direction (e.g., the thickness direction X, which is not repeated below) of the loudspeaker 112 such that many magnetic flux lines of a magnetic field generated by the magnet 1125 may penetrate through the coil 1126.

In some embodiments, the basket 1121 may include a first annular platform 11211 and a second annular platform 11212 which are arranged in a stepped manner. The second annular platform 11212 may be arranged around a periphery of the first annular platform 11211. A portion of a lower end of the support 115 may be supported on the first annular platform 11211, and another portion of the lower end of the support 115 may form a spacing region with the second annular platform 11212, such that the support 115, the basket 1121, and the core housing 111 cooperate to form a second glue groove 1172. The second glue groove 1172 may contain a second glue for sealing an assembly gap between any two of the support 115, the basket 1121, and the core housing 111 to perform corresponding waterproof sealing.

In some embodiments, an upper end of the support 115 may be disposed on the basket 1121, and cooperate with the basket 1121 and the magnetic shield 1122 to form a third glue groove 1173. The third glue groove 1173 may contain a third glue for sealing an assembly gap between the support 115 and the basket 1121 and the magnetic shield 1122 to perform corresponding waterproof sealing.

It should be noted that in the specific assembly process of the core module 11, the following process operations may be included, and the order of all process operations may be adjusted as needed. 1) The acoustic resistance net 118 and the protective steel net 119 may be pre-fixed at the bottom of the concave region 1119 through the double-sided tape; 2) the loudspeaker 112 may be fixed on the bottom wall 1113, and the glue may be dispensed to an assembly gap between the loudspeaker 112 and the bottom wall 1113, a corresponding glue portion being accumulated on the second annular platform 11212 of the loudspeaker 112; 3) before the glue in the operation 2) is cured, the support 115 may be fixed on the loudspeaker 112, where the lower end of the support 115 may be supported on the first annular platform 11211 of the loudspeaker 112 to make a space between the lower end of the support 115 and the second annular platform 11212 be filled with the glue, the docking portion 1153 of the support 115 may press the acoustic resistance net 118 and cooperate with the first sidewall 1114 to form the first glue groove 1171, the upper end of the support 115 may be on the basket 1121 and cooperate with the basket 1121 and the magnetic shield 1122 to form the third glue groove 1173; and 4) the glue may be dispensed to the assembly gap between the first glue groove 1171, the third glue groove 1173, and the lower end of the support 115, and the loudspeaker 112 and the core inner housing 1111. Since the assembly gap between the lower end of the support 115 and the loudspeaker 112 and the core inner housing 1111 is very close to the first glue groove 1171, the assembly gap between the lower end of the support 115 and the loudspeaker 112 and the core inner housing 1111 may be simply regarded as a continuation of the first glue groove 1171. That is, the first glue groove 1171 and the second glue groove 1172 may be connected.

According to the above detailed description, the waterproof performance of the earphone 10 at the assembly point of the support 115 and the core housing 111 may be improved through the first glue (and the second glue) or the silicone sleeve, such that the space where the main control circuit board 13 is located in the core housing 111 has a relatively high waterproof level. Accordingly, a first accommodation space connected with the acoustic cavity 116 may be disposed inside the loudspeaker 112, and the loudspeaker 112, the support 115, and the core housing 111 may further cooperate to form a second accommodation space that is not connected with the acoustic cavity 116 outside the loudspeaker 112. The first accommodation space may be formed by the basket 1121, the magnetic shield 1122, the diaphragm 1123, and the folded ring 1124 through cooperation, and thus the magnet 1125, the coil 1126, the magnetic conductive plate 1127 and other structures may be arranged in the first accommodation space; the main control circuit board 13 and other structures may be arranged in the second accommodation space. In other words, for the loudspeaker 112, the first accommodation space and the second accommodation space may be two spaces with a certain volume inside and outside the loudspeaker 112, respectively. It should be noted that the first accommodation space may be connected with the acoustic cavity 116 through a through hole 11213 disposed on the basket 1121. In the embodiment where the acoustic hole is the pressure relief hole 111c (or the tuning hole 111d), the through hole 11213 may be disposed on a side of the basket 1121 close to the pressure relief hole 111c (or the tuning hole 111d). In the embodiment where the acoustic hole is the pressure relief hole 111c and the tuning hole 111d, two through holes 11213 may be provided, where one of the two through holes 11213 may be disposed on one side of the basket 1121 close to the pressure relief hole 111c, and the other of the two through holes 11213 may be disposed on the other side of the basket 1121 close to the tuning hole 111d.

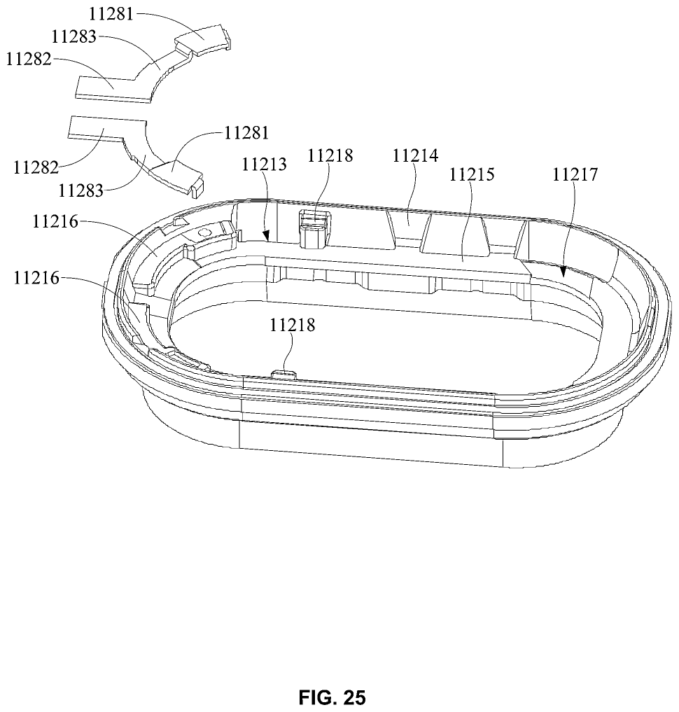

In some embodiments, referring to FIG. 23 and FIG. 25, the loudspeaker 112 may include a metal part 1128 disposed on the basket 1121. Two metal parts 1128 may be provided, where one of the two metal parts 1128 may be used as a positive terminal of the loudspeaker 112, and the other of the two metal parts 1128 may be used as a negative terminal of the loudspeaker 112. Each of the two metal parts 1128 may include a first soldering pad 11281 and a second soldering pad 11282, and a transition portion 11283 connecting the first soldering pad 11281 and the second soldering pad 11282. The first soldering pad 11281 and the second soldering pad 11282 may be exposed from the basket 1121. In this case, the first soldering pad 11281 may be located in the first accommodation space and connected with the coil 1126, and the second soldering pad 11282 may be located in the second accommodation space, such that the coil 1126 may be connected with the main control circuit board 13 through the metal part 1128. A distance between the first soldering pads 11281 of the two metal parts 1128 may be greater than a distance between the second soldering pads 11282 of the two metal parts 1128. In this way, although the first soldering pads 11281 are arranged in the first accommodation space with a relatively low waterproof level, the distance between the first soldering pads 11281 of the two metal parts 1128 is relatively large, such that the sweat, rain and other liquid droplets that invade the first accommodation space through the acoustic hole (e.g., the pressure relief hole 111c or the tuning hole 111d) and the acoustic channel 1151 are not likely to cause a short circuit between the first soldering pads 11281 of the two metal parts 1128, thereby preventing the earphone 10 from being burned. In addition, since the second soldering pads 11282 are arranged in the second accommodation space with a relatively high waterproof level, the distance between the second soldering pads 11282 of the two metal parts 1128 is relatively small, such that the earphone 10 is not short-circuited, thereby preventing the earphone 10 from being burned. Furthermore, since the distance between the second soldering pads 11282 of the two metal parts 1128 is small, conductors or flexible circuit boards connecting the two metal parts 1128 and the main control circuit board 13 may be shortened, thereby simplifying the wiring structure of the loudspeaker 112, and reducing cost.

In some embodiments, referring to FIG. 23, the basket 1121 may have a long axis direction (e.g., the length direction Y) and a short axis direction (e.g., the width direction Z) which are perpendicular to the vibration direction of the loudspeaker 112 and orthogonal to each other. A size of the basket 1121 in the long axis direction may be greater than a size of the basket 1121 in the short axis direction. For example, a length-width relationship of the basket 1121 may match a length-width relationship of the core module 11. In this case, the two metal parts 1128 may be located at the same end in the long axis direction to simplify the wiring of the earphone 10. Correspondingly, the two metal parts 1128 may be located between the two through holes 11213 in the width direction.

In some embodiments, the transition portion 11283 may be embedded in the basket 1121. For example, the metal parts 1128 and the basket 1121 may be injection molded through a metal insert process. In this way, since the transition portion 11283 is not exposed from the basket 1121, a distance between the transition portions 11283 of the two metal parts 1128 is small, which does not cause short circuit, thereby preventing the earphone 10 from being burned.

In some embodiments, the transition portions 11283 may be sealed on the basket 1121 in a waterproof manner. For example, the metal parts 1128 may be first fixed on the basket 1121 and then the transition portions 11283 may be covered with the glue. In this way, even if the distance between the transition portions 11283 of the two metal parts 1128 is small, the transition portions 11283 are sealed on the basket 1121 in a waterproof manner, such that the transition portions 11283 of the two metal parts 1128 are not short-circuited, thereby preventing the earphone 10 from being burned.

In some embodiments, referring to FIG. 25, the second soldering pads 11282 of the two metal parts 1128 may be arranged at intervals side by side. One end of each transition portion 11283 may be connected with the corresponding second soldering pad 11282. The two transition portions 11283 may extend in directions away from each other, and each first soldering pad 11281 may be connected with the other end of the corresponding transition portion 11283, such that the distance between the first soldering pads 11281 of the two metal parts 1128 may be greater than the distance between the second soldering pads 11282 of the two metal parts 1128. A curvature of the transition portion 11283 may be consistent with a change trend of a region where the metal parts 1128 are disposed on the basket 1121.

In some embodiments, referring to FIG. 25, the basket 1121 may include an annular peripheral wall 11214 and an annular flange 11215 connected with an inner wall surface of the annular peripheral wall 11214, and a boss 11216 disposed at a connection between the annular flange 11215 and the annular peripheral wall 11214. The magnetic shield 1122 may be fixed on the annular flange 11215, such that the magnetic shield 1122 may be connected with the basket 1121. The boss 11216 may be configured to support the metal parts 1128, such that the transition portions 11283 may be hidden in the boss 11216 and the second soldering pads 11282 may be exposed from the boss 11216, so as to facilitate the connection between the coil 1126 and the metal parts 1128, and avoid short circuit between the transition portions 11283 of the two metal parts 1128.

In some embodiments, referring to FIG. 23 and FIG. 25, two bosses 11216 may be arranged at intervals along a circumferential direction of the annular peripheral wall 11214. For example, one boss 11216 may be broken in the middle and divided into two bosses 11216. In this case, each of the two bosses 11216 may support one metal part 1128. That is, the transition portions 11283 of the two metal parts 1128 may be hidden in the bosses 11216, respectively. In this way, even if the liquid droplets such as sweat, rainwater, or the like, are accumulated on one of the bosses 11216 and the second soldering pad 11282 exposed thereon, the liquid droplets are difficult to flow to the other boss 11216 and the second soldering pad 11282 exposed thereon, thereby avoiding short circuit between the second soldering pads 11282 of the two metal parts 1128.

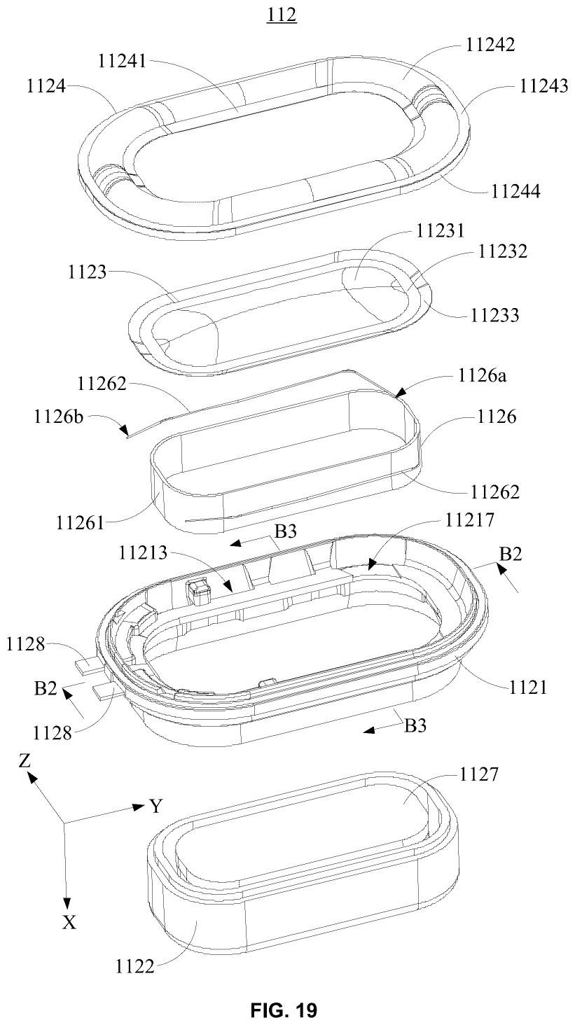

In some embodiments, referring to FIG. 19 and FIG. 23, the coil 1126 may include an annular body 11261 and a lead wire 11262 connected with the annular body 11261. The annular body 11261 and the lead wire 11262 may be the same conductor. Accordingly, the annular body 11261 may be obtained by winding the conductor with a certain count of turns according to actual needs. The annular body 11261 may be connected with the diaphragm 1123. The lead wire 11262 may be two ends of the conductor. That is, two lead wires 11262 may be provided, and the two lead wires 11262 may be connected with the second soldering pads 11282 of the two metal parts 1128 one by one. Further, the annular body 11261 may be located on an inner side of the basket 1121. For example, the annular body 11261 may extend into the magnetic gap formed between the magnet 1125 and the magnetic shield 1122. After an excitation signal is input into the loudspeaker 112, the lead wires 11262 may move along with the annular body 11261 relative to the basket 1121, and the annular body 11261 may push the diaphragm 1123 to generate sound waves.

In some embodiments, referring to FIG. 23, an avoidance groove 11217 may be disposed on the basket 1121, and an orthographic projection of each of the lead wires 11262 along the vibration direction of the loudspeaker 112 may at least partially fall within the avoidance groove 11217. A depth of the avoidance groove 11217 may be greater than 0 and less than or equal to 0.2 mm. In this way, a distance between the lead wires 11262 and the basket 1121 may be increased to a certain extent by the avoidance groove 11217, so as to reduce the risk of the lead wires 11262 colliding with the basket 1121 when the lead wires 11262 move along with the annular body 11261 relative to the basket 1121, especially when the loudspeaker 112 operates at a small amplitude, and reduce the travel of the lead wires 11262 after colliding with the basket 1121, especially when the loudspeaker 112 operates at a large amplitude, thereby improving the reliability of the loudspeaker 112.

In some embodiments, in the vibration direction of the loudspeaker 112, when no excitation signal is input into the loudspeaker 112, a distance between each of the lead wires 11262 and a bottom of the avoidance groove 11217 may be greater than the maximum amplitude of a movement of the lead wires 11262 relative to the basket 1121, so as to further reduce the risk of the lead wires 11262 colliding with the basket 1121 and reduce the travel of the lead wires 11262 after colliding with the basket 1121.

In some embodiments, the avoidance groove 11217 may be close to one end of each of the lead wire 11262 connected with the annular body 11261. That is, the avoidance groove 11217 may be arranged corresponding to a position where the lead wires 11262 have a relatively large movement along with the movement of the annular body 11261, the position being a position where the risk of the lead wires 11262 colliding with the basket 1121 is relatively high, so as to further reduce the risk of the lead wires 11262 colliding with the basket 1121 and reduce the travel of the lead wires 11262 after colliding with the basket 1121.

In some embodiments, referring to FIG. 23, each of the lead wires 11262 may include a first extension portion 11263 connected with the annular body 11261 and a second extension portion 11264 bent relative to the first extension portion 11263. An orthographic projection of the first extension portion 11263 along the vibration direction of the loudspeaker 112 may at least partially fall within the avoidance groove 11217, so as to reduce the risk of the lead wires 11262 colliding with the basket 1121 and reduce the travel of the lead wires 11262 after colliding with the basket 1121. At least a portion of an orthographic projection of the second extension portion 11264 along the vibration direction of the loudspeaker 112 close to the first extension portion 11263 may fall within the avoidance groove 11217, so as to further reduce the risk of the lead wires 11262 colliding with the basket 1121 and reduce the travel of the lead wires 11262 after colliding with the basket 1121. Correspondingly, one end of the second extension portion 11264 away from the first extension portion 11263 may be connected with the second soldering pad 11282. In some embodiments, each of the lead wires 11262 may be arranged as a straight line or an arc as a whole.

In some embodiments, a ratio of a length of the second extension portion 11264 to a length of the first extension portion 11263 may be in a range of 2-15. If the ratio is too small, an amplitude of the end of the second extension portion 11264 away from the first extension portion 11263 may still be large, which may cause the second extension portion 11264 to be disconnected or desoldered at the second soldering pad 11282; if the ratio is too large, a weight of the second extension portion 11264 may be too large and the first extension portion 11263 may be excessively pulled, which may cause the overall size of the loudspeaker 112 to be excessively large and may not be conducive to product miniaturization. Further, a distance between the second extension portion 11264 and the annular body 11261 in a direction (e.g., the width direction Z) perpendicular to the vibration direction of the loudspeaker 112 may be in a range of 1.1-2.1 mm. If the distance is too small, the amplitude of the second extension part 11264 may still be large, which may easily cause the second extension portion 11264 to collide with the basket 1121, and the second extension portions 11264 may be disconnected or desoldered at the second soldering pad 11282; if the distance is too large, the first extension portion 11263 may over-deform towards the basket 1121 due to an excessive weight of the first extension portion 11263, which may easily cause the first extension portion 11263 to collide with the basket 1121, and may cause the overall size of the loudspeaker 112 to be excessively large and may not be conducive to product miniaturization.

In some embodiments, referring to FIG. 23, an angle between the second extension portion 11264 and the first extension portion 11263 may be an obtuse angle, which reduces a stress between the second extension portion 11264 and the first extension portion 11263, thereby increasing the reliability of the lead wires 11262.

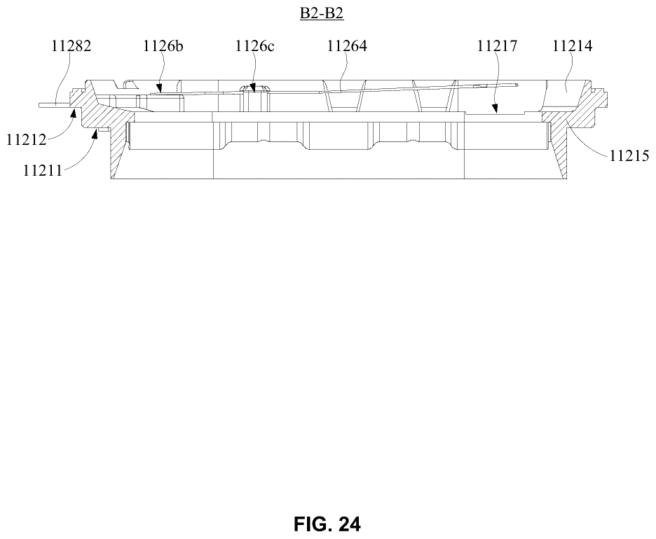

In some embodiments, referring to FIG. 24, a distance between at least a portion of the second extension portion 11264 and the basket 1121 in the vibration direction of the loudspeaker 112 may gradually decrease in an extension direction (e.g., an opposite direction of an arrow Y) away from the first extension portion 11263, such that a portion of the second extension portion 11264 close to the first extension portion 11263 and the first extension portion 11263 are as far away from the basket 1121 as possible in the vibration direction of the loudspeaker 112, thereby reducing the risk of the lead wires 11262 colliding with the basket 1121 and reducing the travel of the lead wires 11262 after colliding with the basket 1121.

In some embodiments, the basket 1121 may be provided with a plurality of through holes 11213 spaced around the annular body 11261. The avoidance groove 11217 may be connected with the through holes 11213 to simplify the structure of the basket 1121. An orthographic projection of the second extension portion 11264 along the vibration direction of the loudspeaker 112 may at least partially fall within the through holes 11213 to reduce an area where the second extension portion 11264 may collide with the basket 1121, thereby increasing the reliability of the loudspeaker 112. The plurality of through holes 11213 may be divided into two sets of through holes 11213, and the orthographic projections of the second extension portions 11264 of the two lead wires 11262 along the vibration direction of the loudspeaker 112 may at least partially fall within the through holes 11213. Accordingly, each set of through holes 11213 of the two sets of through holes 11213 may include a plurality of through holes 11213 spaced from each other, such as four through holes 11213 shown in FIG. 23. Each set of through holes 11213 of the two sets of through holes 11213 may include only one relatively large through hole 11213.

In some embodiments, referring to FIG. 23 and FIG. 25, soldering pads connected with the lead wires 11262 may be provided on the basket 1121, and two soldering pads may be provided. One of the two soldering pads may be used as a positive terminal of the loudspeaker 112, and the other of the two soldering pads may be used as a negative terminal of the loudspeaker 112. The soldering pads may be the metal parts 1128 described above, or may be other configures known to those skilled in the art, which are not repeated below. In some embodiments, each of the lead wires 11262 may include a first end 1126a close to the annular body 11261 and a second end 1126b away from the annular body 11261. The second end 1126b may be fixed on the corresponding soldering pad. For example, one end of each of the lead wires 11262 away from the annular body 11261 may be soldered on a first soldering pad 11281. A ratio of a length of each of the lead wires 11262 to the maximum amplitude of the movement of the coil 1126 relative to the basket 1121 may be in a range of 8-75. If the ratio is too small, the amplitude of the second end 1126b may still be large, which may cause the lead wires 11262 to be disconnected or desoldered at the soldering pads; if the ratio is too large, the lead wires 11262 may over-deform towards the basket 1121 due to the excessive weight of the lead wires 11262, which may cause the lead wires 11262 to collide with the basket 1121, and may cause the overall size of the loudspeaker 112 to be excessively large, which is not conducive to product miniaturization. In summary, the technical solution can improve the technical problem of stress concentration of the lead wires 11262.

In some embodiments, a ratio of a wire diameter of each of the lead wires 11262 to the length of each of the lead wires 11262 may be in a range of 50-1000. If the ratio is too small, the lead wires 11262 may be easily disconnected due to too low rigidity; if the ratio is too large, the lead wires 11262 may over-deform towards the basket 1121 due to the excessive weight, which may cause the lead wires 11262 to collide with the basket 1121.

In some embodiments, a fixed position 1126c of the lead wire 11262 between the first end 1126a and the second end 1126b may be fixed on the basket 1121, such that the vibration of the lead wire 11262 along with the annular body 11261 is difficult to be transmitted to the soldering pad, which prevents resonance at an end of the lead wire 11262 close to the soldering pad or a peak frequency of the resonance shifting to a higher frequency band (e.g., above 10 kHz), thereby reducing the risk of the lead wire 11262 being disconnected or desoldered at the soldering pad. A portion of the lead wire 11262 between the first end 1126a and the fixed position 1126c may be suspended relative to the basket 1121, and a portion of the lead wire 11262 between the second end 1126b and the fixed position 1126c may also be suspended relative to the basket 1121, so as to reduce the risk of the lead wire 11262 colliding with the basket 1121.

In some embodiments, referring to FIG. 19 and FIG. 23, a support block 11218 may be provided on the basket 1121. The support block 11218 may be located between the first end 1126a and the second end 1126b, and may correspond to the fixed position 1126c. In this case, the lead wire 11262 may be fixed on the support block 11218 at the fixed position 1126c, such that at least a portion of the lead wire 11262 may be suspended relative to the basket 1121. In this way, since the support block 11218 is a portion of the structure of the basket 1121, the fixed position 1126c is accurate, which prevents a worker from arbitrarily fixing a certain position of the lead wire 11262 on the basket 1121, thereby improving the product consistency of the loudspeaker 112 in mass production, and improving the yield rate.

It should be noted that in the embodiment where a plurality of through holes 11213 spaced around the annular body 11261 are provided on the basket 1121, the support block 11218 may be located between two adjacent through holes 11213, which makes the structure simple and reliable. In addition, the support block 11218 may serve as a reinforcement rib of the basket 1121 to increase the structural strength of the basket 1121. In some embodiments, for the lead wire 11262 corresponding to the positive terminal or the negative terminal of the loudspeaker 112, a plurality of fixed positions 1126c and a plurality of support blocks 11218 corresponding to the plurality of fixed positions 1126c may be provided. For example, two or three fixed positions 1126c and two or three support blocks 11218 corresponding to the two or three fixed positions 1126c may be provided.

In some embodiments, the lead wire 11262 may be fixed on the support block 11218 through glue 11219, and the glue 11219 may be elastic after curing, such as silicone and other flexible glue. In this way, the vibration of the lead wire 11262 along with the annular body 11261 may be absorbed, and the stress of the lead wire 11262 at the fixed position 1126c may be reduced, thereby reducing the risk of the lead wire 11262 being disconnected. In some embodiments, in an application scenario with a relatively low risk of disconnection, the glue 11219 may be rigid glue.

In some embodiments, a limiting groove may be provided on a side of the support block 11218 that contacts the lead wire 11262, which increases the consistency of the relative position of the support block 11218 and the lead 11262 in mass production, thereby improving the yield rate of the product. It should be noted that in the embodiment where the lead wire 11262 is fixed on the support block 11218 through the glue 11219, the avoidance groove may serve as a glue groove, such that sufficient glue 11219 may be accumulated on the support block 11218 to fix the lead wire 11262.

In some embodiments, a first length of the lead wire 11262 between the first end 1126a and the support block 11218 may be greater than a second length of the lead wire 11262 between the second end 1126b and the support block 11218. In this way, the risk of the lead wire 11262 being disconnected due to the first length being too short is reduced while the total length of the lead wire 11262 remains constant. Merely by way of example, a ratio of the first length to the second length may be in a range of 1-12. If the ratio is too small, the amplitude of the lead wire 11262 at the support block 11218 may still be large, which may easily cause the lead wire 11262 to be disconnected.

In some embodiments, when no excitation signal is input into the loudspeaker 112, the first end 1126a and the fixed position 1126c where the lead wire 11262 is supported by the support block 11218 may be on a same reference plane perpendicular to the vibration direction of the loudspeaker 112, which reduces the stress in the lead wire 11262, thereby reducing the risk of the lead wire 11262 being disconnected.

In some embodiments, referring to FIG. 23, the second extension portion 11264 may be fixed on the support block 11218 and the soldering pad. For example, the second extension portion 11264 may be soldered on the soldering pad at the second end 1126b and may be fixed on the support block 11218 at the fixed position 1126c through the glue 11219. The end of the second extension portion 11264 connected with the first extension portion 11263 may be used as a starting point of the second extension portion 11264, and the second end 1126b may be used as an end point of the second extension portion 11264. A position (e.g., the fixed position 1126c) where the second extension portion 11264 is fixed on the support block 11218 may be located between a position of one-half of the length of the second extension portion 11264 and a position of three-quarters of the length of the second extension portion 11264.

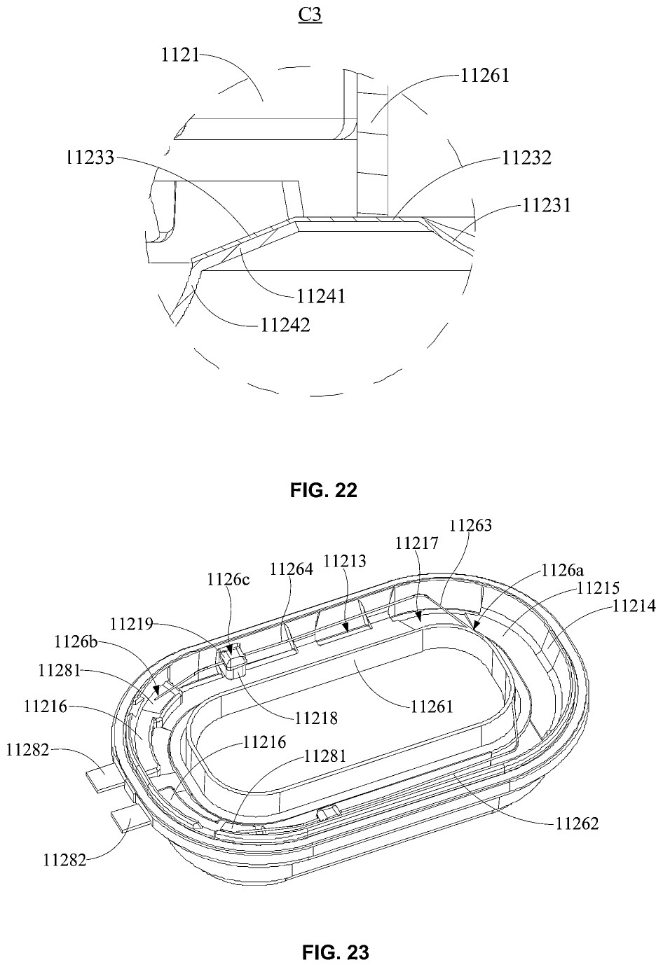

In some embodiments, referring to FIG. 19, FIG. 21, and FIG. 22, the diaphragm 1123 may include a body 11231, a first annular connection portion 11232, and a second annular connection portion 11233 which are integrally connected. The first annular connection portion 11232 may be connected with the coil 1126, and the second annular connection portion 11233 may be connected with the folded ring 1124. The body 11231 may be configured as a dome structure protruding in a direction away from the coil 1126. Further, an orthographic projection of the second annular connection portion 11233 in the vibration direction of the loudspeaker 112 may cover the lead wire 11262, and the second annular connection portion 11233 may be bent relative to the first annular connection portion 11232 towards a side away from the coil 1126, such that a distance is formed between the second annular connection portion 11233 and the lead wire 11262 in the vibration direction of the loudspeaker 112, which avoids unnecessary collision between the lead wire 11262 and the folded ring 1124 or the diaphragm 1123 connected therewith.

In some embodiments, referring to FIGS. 19-22, the folded ring 1124 may include a third annular connection portion 11241, a pleated portion 11242, and a fourth annular connection portion 11243 which are integrally connected. The third annular connection portion 11241 may be connected with a side of the second annular connection portion 11233 away from the coil 1126, and the fourth annular connection portion 11243 may be connected with the basket 1121 (e.g., the annular peripheral wall 11214) through a reinforcement member 11244. Further, the pleated portion 11242 may protrude in a direction away from the lead wire 11262, which avoids unnecessary collision between the pleated portion 11242 and the lead wire 11262.

According to the above related description, the present disclosure provides an electronic device. The electronic device may include a support component and the core module 11. The support component may be connected with the core housing 111 to support the core module 11 to be worn to a wearing position. The support component may be configured as an ear hook structure (e.g., the hook structure 12) hung on the ear in the wearing state, and may also be configured as a head beam structure that bypasses the top of the head in the wearing state. In some embodiments, the wearing position may be a position of the cheek of the user close to the ear, a certain position on the front side of the ear, or other physiological parts of the user. Accordingly, in addition to the earphone 10, the electronic device may be a terminal device such as smart glasses including the core module 11. In addition to including the loudspeaker 112, the core module 11 may further include a transducer device based on a bone conduction principle. For example, the electronic device may include the loudspeaker 112, and the loudspeaker 112 may be configured to generate an air conduction sound. For the electronic device including the loudspeaker 112, the electronic device may also be a terminal device such as a mobile phone, a smart watch, etc.

The above descriptions are only some embodiments of the present disclosure, and are not intended to limit the protection scope of the present disclosure. Any equivalent device or equivalent process transformation made using the contents of the specification and drawings of the present disclosure, or directly or indirectly used in other related technical fields is also included in the patent protection scope of the present disclosure.

1. A loudspeaker, comprising a basket and a coil, wherein the coil includes an annular body and a lead wire connected with the annular body, the annular body is located on an inner side of the basket, and the lead wire moves along with the annular body relative to the basket after an excitation signal is input into the loudspeaker; wherein
a soldering pad is disposed on the basket, the lead wire is provided with a first end close to the annular body and a second end away from the annular body, the second end is fixed on the soldering pad, and a ratio of a length of the lead wire to a maximum amplitude of a movement of the coil relative to the basket is in a range of 8-75.

2. The loudspeaker of claim 1, wherein a ratio of a diameter of the lead wire to the length of the lead wire is in a range of 50-1000.

3. The loudspeaker of claim 1, wherein the lead wire includes a first extension portion connected with the annular body and a second extension portion bent relative to the first extension portion, and a ratio of a length of the second extension portion to a length of the first extension portion is in a range of 2-15.

4. The loudspeaker of claim 3, wherein a distance between the second extension portion and the annular body in a direction perpendicular to a vibration direction of the loudspeaker is in a range of 1.1 mm-2.1 mm.

5. The loudspeaker of claim 3, wherein an angle between the second extension portion and the first extension portion is an obtuse angle.

6. The loudspeaker of claim 1, wherein the lead wire is fixed on the basket at a fixed position between the first end and the second end, and a portion of the lead wire between the first end and the fixed position is suspended relative to the basket.

7. The loudspeaker of claim 6, wherein a support block is disposed on the basket, the support block is located between the first end and the second end and corresponds to the fixed position, the lead wire is fixed on the support block at the fixed position, and when no excitation signal is input into the loudspeaker, the first end and the fixed position are on a same reference plane perpendicular to a vibration direction of the loudspeaker.

8. The loudspeaker of claim 1, further comprising: a magnetic shield connected with the basket, a magnet disposed in the magnetic shield, a diaphragm connected with the coil, and a folded ring connecting the diaphragm and the basket, the coil extending into a magnetic gap formed by the magnet and the magnetic shield; wherein the diaphragm includes a body portion, a first annular connection portion, and a second annular connection portion which are integrally connected, the first annular connection portion is connected with the coil, the second annular connection portion is connected with the folded ring, an orthographic projection of the second annular connection portion in a vibration direction of the loudspeaker covers the lead wire, and the second annular connection portion is bent towards a side away from the coil relative to the first annular connection portion.

9. The loudspeaker of claim 8, wherein the folded ring includes a third annular connection portion, a pleated portion, and a fourth annular connection portion which are integrally connected, the third annular connection portion is connected with a side of the second annular connection portion away from the coil, the fourth annular connection portion is connected with the basket through a reinforcement member, and the pleated portion protrudes in a direction away from the lead wire.

10. An electronic device, comprising a loudspeaker, wherein the loudspeaker includes:
a basket and a coil, wherein the coil includes an annular body and a lead wire connected with the annular body, the annular body is located on an inner side of the basket, and the lead wire moves along with the annular body relative to the basket after an excitation signal is input into the loudspeaker; wherein
a soldering pad is disposed on the basket, the lead wire is provided with a first end close to the annular body and a second end away from the annular body, the second end is fixed on the soldering pad, and a ratio of a length of the lead wire to a maximum amplitude of a movement of the coil relative to the basket is in a range of 8-75.

11. The loudspeaker of claim 7, wherein a limiting groove is provided on a side of the support block that contacts the lead wire.

12. The loudspeaker of claim 7, wherein a first length of the lead wire between the first end and the support block is greater than a second length of the lead wire between the second end and the support block.

13. The loudspeaker of claim 12, wherein a ratio of the first length to the second length is in a range of 1-12.

14. The loudspeaker of claim 1, wherein an avoidance groove is disposed on the basket, and an orthographic projection of the lead wires along a vibration direction of the loudspeaker at least partially falls within the avoidance groove.

15. The loudspeaker of claim 14, wherein a support block is disposed on the basket, the support block is located between the first end and the second end, a plurality of through holes spaced around the annular body are provided on the basket, and the support block is located between two adjacent through holes of the plurality of through holes.

16. The loudspeaker of claim 14, wherein the lead wire includes a first extension portion connected with the annular body and a second extension portion bent relative to the first extension portion, an orthographic projection of the first extension portion along the vibration direction of the loudspeaker at least partially falls within the avoidance groove.

17. The loudspeaker of claim 16, wherein at least a portion of an orthographic projection of the second extension portion along the vibration direction of the loudspeaker close to the first extension portion falls within the avoidance groove.

18. The loudspeaker of claim 16, wherein a distance between at least a portion of the second extension portion and the basket in the vibration direction gradually decreases in an extension direction away from the first extension portion.

19. The loudspeaker of claim 16, wherein the basket is provided with a plurality of through holes spaced around the annular body, the avoidance groove is connected with the plurality of through holes, and an orthographic projection of the second extension portion along the vibration direction at least partially falls within the through holes.

20. The loudspeaker of claim 14, wherein the avoidance groove is close to an end of the lead wire connected with the annular body.
